(19) United States
(12) Patent Application Publication
(10) Pub. No.: US 2023/0125854 A1
(43) Pub. Date: Apr. 27, 2023

(54) ELECTRONIC COMPONENT

(71) Applicant: TDK CORPORATION, Tokyo (JP)

(72) Inventors: Yusuke NAGAI, Tokyo (JP); Kazuhiro EBINA, Tokyo (JP); Takahiro SATO, Tokyo (JP); Kunihiko KAWASAKI, Tokyo (JP); Shinichi SATO, Tokyo (JP); Seiichi NAKAGAWA, Tokyo (JP); Kouichi KAKUDA, Tokyo (JP); Mitsuharu KOIKE, Tokyo (JP); Keito YASUDA, Tokyo (JP); Takato SASAKI, Tokyo (JP)

(73) Assignee: TDK CORPORATION, Tokyo (JP)

(21) Appl. No.: 17/970,182

(22) Filed: Oct. 20, 2022

(30) Foreign Application Priority Data
Oct. 25, 2021 (JP) 2021-173905
Sep. 21, 2022 (JP) 2022-150395

(51) Int. Cl. H01F 5/04; H01F 1/14

(52) U.S. Cl. CPC H01F 5/04; H01F 1/14

(57) ABSTRACT

A stacked coil component includes: an element body, a coil disposed inside the element body; and a first outer electrode and a second outer electrode which are disposed in the element body. Each of the first outer electrode and the second outer electrode includes an electrode portion which includes a joining surface joined to the element body, and a plating surface opposite to the joining surface and is formed by plating, and of which at least a part is embedded in the element body.

### TECHNICAL FIELD

The present disclosure relates to a coil component.

### BACKGROUND

Patent Literature 1 (Japanese Unexamined Patent Publication No. 2018-190490) discloses an electronic component including a ceramic stacked body, an inner electrode layer disposed inside the ceramic stacked body, and an outer electrode that is disposed on a surface of the ceramic stacked body. In the electronic component disclosed in Patent Literature 1, the outer electrode includes an outer electrode layer that is disposed on the surface of the ceramic stacked body and a plated layer that is disposed on the outer electrode layer.

### SUMMARY

An object of an aspect of the present disclosure is to provide a coil component in which surface characteristics of an outer electrode are improved.

According to an aspect of the present disclosure, there is provided a coil component including: an element body; a coil disposed inside the element body; and an outer electrode disposed in the element body. The outer electrode includes an electrode portion which includes a joining surface joined to the element body and a plating surface opposite to the joining surface and is formed by plating, and of which at least a part is embedded in the element body.

In the coil component according to the aspect of the present disclosure, the electrode portion includes the joining surface joined to the element body and the plating surface that is opposite to the joining surface and is formed by plating. As described above, in the coil component, since a surface that is opposite to the joining surface in the electrode portion, that is, a surface of the electrode portion is the plating surface, a surface of the electrode portion has few cavities (voids). According to this, the surface of the electrode portion becomes a dense surface with small unevenness and few defects. Even in a case where a plated layer is disposed on the surface of the electrode portion, a surface of the plated layer becomes a dense surface with small unevenness and few defects. Accordingly, in the coil component, an improvement of surface characteristics of the outer electrode is realized. As a result, when solder-mounting the coil component, wettability of a solder can be improved.

In one embodiment, the outer electrode may include one or a plurality of plated layers disposed on the plating surface of the electrode portion. In this configuration, the plating surface of the electrode portion is a dense surface with small unevenness and few defects, the thickness of the plated layer disposed on the plating surface can be reduced. According to this, a stress that occurs at the time of forming the plated layer can be reduced, and the outer electrode can be suppressed from being peeled off from the element body.

In one embodiment, the element body may be constituted by stacking element body layers containing a plurality of metal magnetic particles of a soft magnetic material. In this configuration, the electrode portion can be formed by plating.

In one embodiment, surface roughness of the joining surface may be larger than surface roughness of the plating surface. In this configuration, an improvement in the joining strength between the element body, and the outer electrode can be realized due to an anchor effect. Accordingly, in the coil component, the outer electrode can be suppressed from being peeled off.

In one embodiment, the electrode portion may include a baked electrode layer that includes the joining surface and contains a glass component. In this configuration, an improvement of the joining strength between the element body and the electrode portion can be realized.

According to the aspect of the present disclosure, an improvement of surface characteristics of the outer electrode is realized.

### BRIEF DESCRIPTION OF THE DRAWINGS

FIG. 1 is a perspective view illustrating a stacked coil component according to a first embodiment.

FIG. 2 is a view illustrating a cross-sectional configuration of the stacked coil component illustrated in FIG. 1.

FIG. 3 is an exploded perspective view of the stacked coil component.

FIG. 4 is a view illustrating a cross-sectional configuration of a part of an outer electrode.

FIG. 5 is a view illustrating a cross-sectional configuration of a part of an outer electrode according to a modification example.

FIG. 6 is an exploded perspective view of a stacked coil component according to a second embodiment.

FIG. 7 is an exploded perspective view of the stacked coil component illustrated in FIG. 6.

FIG. 8 is a view illustrating a cross-sectional configuration of a stacked coil component according to a third embodiment.

FIG. 9 is an exploded perspective view of the stacked coil component illustrated in FIG. 8.

### DETAILED DESCRIPTION

Hereinafter, appropriate embodiments of the present disclosure will be described in detail with reference to the accompanying drawings. Note that, in description of the drawings, the same reference numeral will be given to the same or equivalent element, and redundant description will be omitted.

### First Embodiment

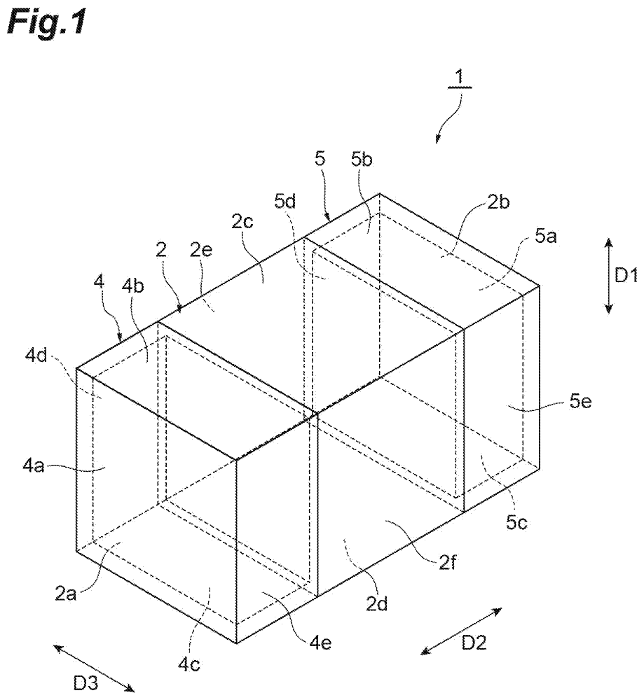

As illustrated in FIG. 1, a stacked coil component 1 according to a first embodiment includes an element body 2, a first outer electrode 4 and a second outer electrode 5 which are respectively disposed at both ends of the element body 2.

The element body 2 has an approximately rectangular parallelepiped shape. The rectangular parallelepiped shape includes a rectangular parallelepiped shape in which corners and ridges are chamfered, and a rectangular parallelepiped shape in which corners and ridges are rounded. The element body 2 includes a pair of end surfaces 2a and 2b opposite to each other, a pair of main surfaces 2c and 2d opposite to each other, and a pair of side surfaces 2e and 2f opposite to each other as outer surfaces. An opposing direction in which the pair of main surfaces 2c and 2d are opposite to each other is a first direction D1. An opposing direction in which the pair of end surfaces 2a and 2b are opposite to each other is a second direction D2. An opposing direction in which the pair of side surfaces 2e and 2f are opposite to each other is a third direction D3. In this embodiment, the first direction D1 is a height direction of the element body 2. The second direction D2 is a longitudinal direction of the element body 2 and is orthogonal to the first direction D1. The third direction D3 is a width direction of the element body 2 and is orthogonal to the first direction D1 and the second direction D2.

The pair of end surfaces 2a and 2b extend in the first direction D1 to connect the pair of main surfaces 2c and 2d to each other. The pair of end surfaces 2a and 2b also extend in the third direction D3 (a short-side direction of the pair of main surfaces 2c and 2d). The pair of side surfaces 2e and 2f extend in the first direction D1 to connect the pair of main surfaces 2c and 2d to each other. The pair of side surfaces 2e and 2f also extend in the second direction D2 (a long-side direction of the pair of end surfaces 2a and 2b). The main surface 2d can be defined as a mounting surface that faces another electronic device (for example, a circuit substrate, an electronic component, or the like) when mounting the stacked coil component 1 on the other electronic device.

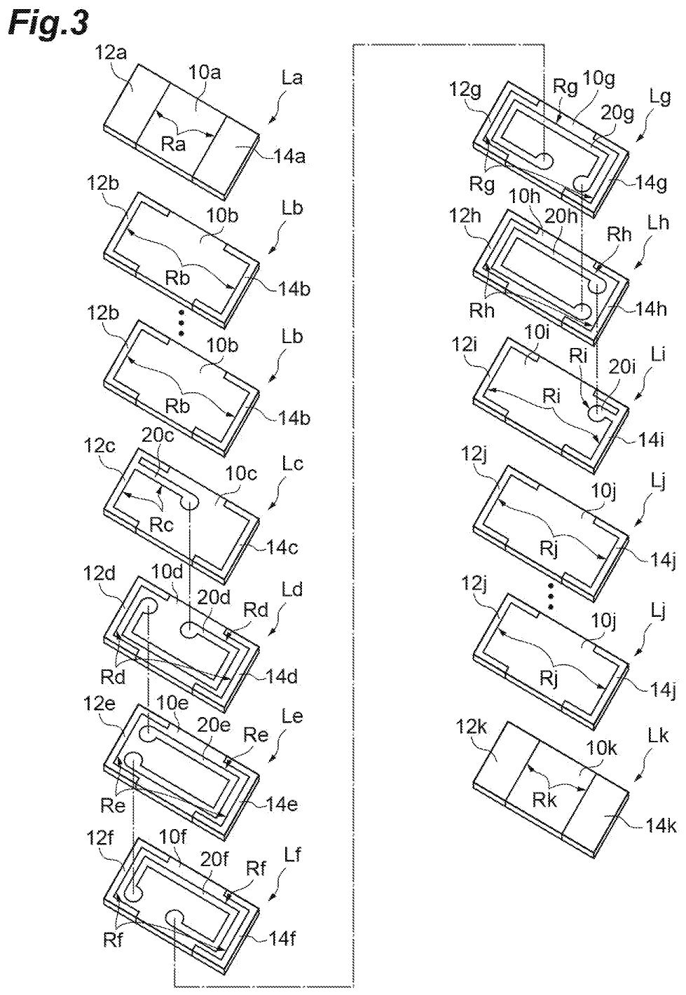

As illustrated in FIG. 3, the element body 2 is constituted by stacking a plurality of element body layers 10a to 10k. The element body layers 10a to 10k are stacked in the first direction D1. That is, the first direction D1 is a stacking direction. The element body 2 includes the plurality of element body layers 10a to 10k stacked on each other. In an actual element body 2, the plurality of element body layers 10a to 10k are integrated with each other to a certain extend in which a boundary between layers cannot be visually recognized.

Each of the element body layers 10a to 10k includes contains a plurality of metal magnetic particles. The metal magnetic particles are composed of a soft magnetic alloy (soft magnetic material). For example, the soft magnetic alloy is an Fe—Si based alloy. In a case where the soft magnetic alloy is the Fe—Si based alloy, the soft magnetic alloy may contain P. For example, the soft magnetic alloy may be an Fe—Ni—Si—M based alloy. “M” includes one or more kinds of elements selected from Co, Cr, Mn, P, Ti, Zr, Hf, Nb, Ta, Mo, Mg, Ca, Sr, Ba, Zn, B, Al, and a rare-earth element.

In the element body layers 10a to 10k, the metal magnetic particles are coupled to each other. For example, coupling of the metal magnetic particles is realized by coupling of oxide films formed on surfaces of the metal magnetic particles. In the element body layers 10a to 10k, the metal magnetic particles are electrically insulated from each other due to coupling between the oxide films. For example, the thickness of each of the oxide films is 5 to 60 nm. The oxide film may be constituted by one or a plurality of layers.

The element body 2 contains a resin. The resin exists between a plurality of metal magnetic particles. The resin is a resin having an electrical insulation property (insulating resin). For example, the insulating resin includes a silicone resin, a phenolic resin, an acrylic resin, or an epoxy resin.

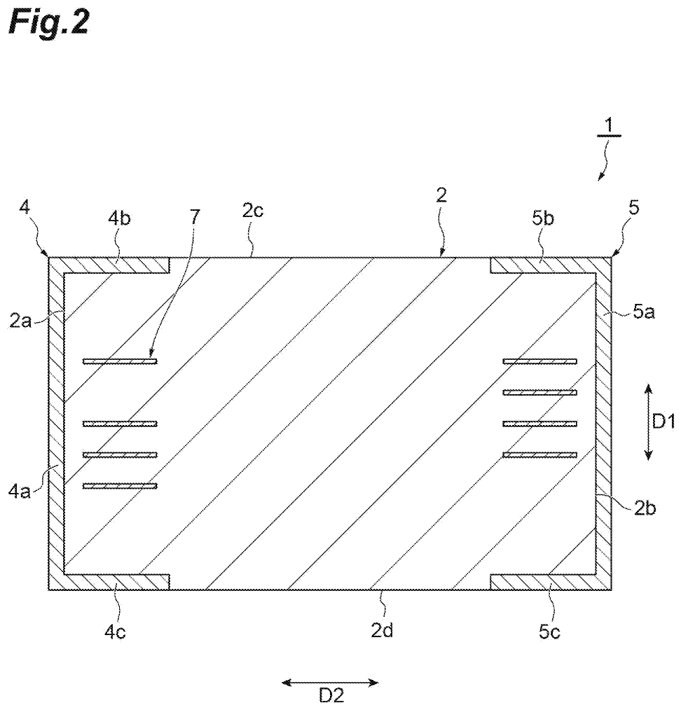

As illustrated in FIG. 2, in the element body 2, a part of the main surface 2c forms a step. Specifically, each of an end surface 2a side and an end surface 2b side of the main surface 2c is further recessed toward the main surface 2d side in comparison to the central portion. In the element body 2, a part of the main surface 2d forms a step. Specifically, each of an end surface 2a side and an end surface 2b side of the main surface 2d is further recessed toward the main surface 2c side in comparison to the central portion.

The first outer electrode 4 is disposed on one end surface 2a side. The first outer electrode 4 includes five electrode portions including a first electrode portion 4a located on the end surface 2a, a second electrode portion 4b located on the main surface 2c, a third electrode portion 4c located on the main surface 2d, a fourth electrode portion 4d located on the side surface 2e, and a fifth electrode portion 4e located on the side surface 2f. The first electrode portion 4a extends along the first direction D1 and the third direction D3, and has a rectangular shape when viewed from the second direction D2. The second electrode portion 4b extends along the second direction D2 and the third direction D3, and has a rectangular shape when viewed from the first direction D1. The third electrode portion 4c extends along the second direction D2 and the third direction D3, and has a rectangular shape when viewed from the first direction D1. The fourth electrode portion 4d extends along the first direction D1 and the second direction D2, and has a rectangular shape when viewed from the third direction D3. The fifth electrode portion 4e extends along the first direction D1 and the second direction D2, and has a rectangular shape when viewed from the third direction D3.

The first electrode portion 4a, the second electrode portion 4b, the third electrode portion 4c, the fourth electrode portion 4d, and the fifth electrode portion 4e are connected at a ridge portion of the element body 2, and are electrically connected to each other. The first outer electrode 4 is formed on five surfaces including one pieces of the end surface 2a, the pair of main surfaces 2c and 2d, and the pair of side surfaces 2e and 2f. The first electrode portion 4a, the second electrode portion 4b, the third electrode portion 4c, the fourth electrode portion 4d, and the fifth electrode portion 4e are integrally formed. In this embodiment, a surface of the second electrode portion 4b is flush with the main surface 2c, and a surface of the third electrode portion 4c is flush with the main surface 2d. In addition, a surface of the fourth electrode portion 4d is flush with the side surface 2e, and a surface of the fifth electrode portion 4e is flush with the side surface 2f. According to this configuration, it can be said that a part of the first outer electrode 4 is embedded in the element body 2.

As illustrated in FIG. 3, the first outer electrode 4 is constituted by stacking a plurality of first outer electrode layers 12a, 12b, 12c, 12d, 12e, 12f, 12g, 12h, 12i, 12j, and 12k in the first direction Dl. That is, a stacking direction of the first outer electrode layers 12a to 12k is the first direction D1. In an actual first outer electrode 4, the plurality of first outer electrode layers 12a to 12k are integrated with each other to a certain extent in which a boundary between the layers cannot be visually recognized.

As illustrated in FIG. 2, the second outer electrode 5 is disposed on one end surface 2b side. The second outer electrode 5 includes five electrode portions including a first electrode portion 5a located on the end surface 2b, a second electrode portion 5b located on the main surface 2c, a third electrode portion 5c located on the main surface 2d, a fourth electrode portion 5d located on the side surface 2e, and a fifth electrode portion 5e located on the side surface 2f. The first electrode portion 5a extends along the first direction D1 and the third direction D3, and has a rectangular shape when viewed from the second direction D2. The second electrode portion 5b extends along the second direction D2 and the third direction D3, and has a rectangular shape when viewed from the first direction D1. The third electrode portion 5c extends along the second direction D2 and the third direction D3, and has a rectangular shape when viewed from the first direction D1. The fourth electrode portion 5d extends along the first direction D1 and the second direction D2, and has a rectangular shape when viewed from the third direction D3. The fifth electrode portion 5e extends along the first direction D1 and the second direction D2, and has a rectangular shape when viewed from the third direction D3.

The first electrode portion 5a, the second electrode portion 5b, the third electrode portion 5c, the fourth electrode portion 5d, and the fifth electrode portion 5e are connected at a ridge portion of the element body 2, and are electrically connected to each other. The second outer electrode 5 is formed on five surfaces including one piece of the end surface 2b, the pair of main surfaces 2c and 2d, and the pair of side surfaces 2e and 2f. The first electrode portion 5a, the second electrode portion 5b, the third electrode portion 5c, the fourth electrode portion 5d, and the fifth electrode portion 5e are integrally formed. In this embodiment, a surface of the second electrode portion 5b is flush with the main surface 2c, and a surface of the third electrode portion 5c is flush with the main surface 2d. A surface of the fourth electrode portion 5d is flush with the side surface 2e, and a surface of the fifth electrode portion 5e is flush with the side surface 2f. According to this configuration, it can be said that a part of the second outer electrode 5 is embedded in the element body 2.

As illustrated in FIG. 3, the second outer electrode 5 is constituted by stacking a plurality of second outer electrode layers 14a, 14b, 14c, 14d, 14e, 14f, 14g, 14h, 14i, 14j, and 14k in the first direction D1. That is, a stacking direction of the second outer electrode layers 14a to 14k is the first direction D1. In an actual second outer electrode 5, the plurality of second outer electrode layers 14a to 14k are integrated with each other to a certain extent in which a boundary between the layers cannot be visually recognized.

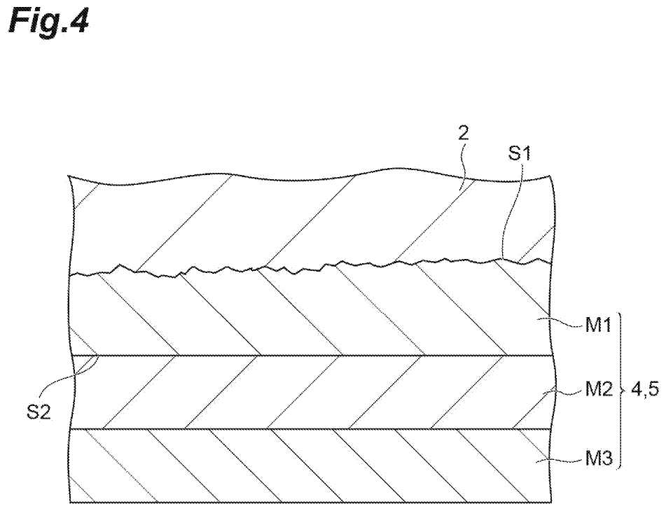

As illustrated in FIG. 4, each of the first outer electrode 4 and the second outer electrode 5 includes a first plated layer (electrode portion) M1, a second plated layer M2, and a third plated layer M3. The first plated layer M1, the second plated layer M2, and the third plated layer M3 are disposed in the order of the first plated layer M1, the second plated layer M2, and the third plated layer M3 from the element body 2 side.

The first plated layer M1 is an Ag plated layer that is formed by Ag plating. The second plated layer M2 is an Ni plated layer that is formed by Ni plating. The third plated layer M3 is an Sn plated layer that is formed by Sn plating. An outer surface of the third plated layer M3 constitutes a surface of the first outer electrode 4 and the second outer electrode 5. The first plated layer M1 is formed by a transfer method to be described later. That is, the first plated layer M1 is not formed by an electrolytic plating method. The second plated layer M2 and the third plated layer M3 are formed by the electrolytic plating method.

The first plated layer M1 includes a joining surface S1 that is joined to the element body 2, and a plating surface S2 that is opposite to the joining surface S1. The joining surface S1 is formed along a surface shape (uneven shape) of the element body 2. The plating surface S2 is a flat surface. Surface roughness of the joining surface S1 is larger than surface roughness of the plating surface S2. In other words, the surface roughness of the plating surface S2 is smaller than the surface roughness of the joining surface S1. The surface roughness (arithmetic average roughness Ra) of the joining surface S1 is 1.1 to 10 times upper surface roughness of the plating surface S2.

In this embodiment, the thickness of the first plated layer M1 is, for example, 5 to 50 μm. The thickness of the second plated layer M2 is, for example, 5 to 10 μm. The thickness of the third plated layer M3 is, for example, 1 to 10 μm.

In this embodiment, in the first plated layer M1, the second plated layer M2, and the third plated layer M3, in a case of measuring an area of voids in a cross-section, a void ratio (an area of voids/a total area of a conductor) is, for example, 98% or more. The void ratio is obtained as follows.

A cross-sectional image of the stacked coil component 1 including the first plated layer M1, the second plated layer M2, and the third plated layer M3 is acquired. For example, the cross-sectional image is obtained by imaging a cross-section when the stacked coil component 1 is cut out in a plane that is parallel to the pair of end surfaces 2a and 2b and is distant from the end surface 2a on one side by a predetermined distance. The plane may be located at an equidistance from the pair of end surfaces 2a and 2b. The cross-sectional image may also be obtained by imaging a cross-section when cutting the stacked coil component 1 at a plane that is parallel to the pair of side surfaces 2e and 2f and is distant from the side surface 2e on one side by a predetermined distance. On the acquired cross-sectional image, an area of voids in the cross-section of each of the first plated layer M1, the second plated layer M2, and the third plated layer M3 is measured, and the void ratio is calculated.

In the stacked coil component 1, as illustrated in FIG. 2, a coil 7 is disposed inside the element body 2. As illustrated in FIG. 3, the coil 7 is constituted by connecting coil conductor layers 20c, 20d, 20e, 20f, 20g, 20h, and 20i to each other. A coil axis of the coil 7 is provided along the first direction D1. The coil conductor layers 20c to 20i are arranged so that at least parts overlap each other when viewed from the first direction D1.

The coil conductor layers 20c to 20i are constituted by a conductive material (for example, Ag or Pd). The respective layers may be constituted by the same material or may be constituted by materials different from each other.

As illustrated in FIG. 3, the stacked coil component 1 includes a plurality of layers La, Lb, Lc, Ld, Le, Lf, Lg, Lh, Li, Lj, and Lk. For example, the stacked coil component 1 is constituted by stacking a layer La, two layers Lb, a layer Lc, a layer Ld, a layer Le, a layer Lf, a layer Lg, a layer Lh, a layer Li, two layers Lj, and a layer Lk sequentially from the main surface 2c side.

The layer La is constituted by an element body layer 10a, and a first outer electrode layer 12a and a second outer electrode layer 14a. The element body layer 10a is provided with a cut-out portion Ra which has a shape corresponding to a shape of the first outer electrode layer 12a and the second outer electrode layer 14a, and into which the first outer electrode layer 12a and the second outer electrode layer 14a are fitted. The element body layer 10a, and the entirety of the first outer electrode layer 12a and the second outer electrode layer 14a have a complementary relationship with each other.

Each of the layers Lb is constituted by combining an element body layer 10b, and a first outer electrode layer 12b and a second outer electrode layer 14b with each other. The element body layer 10b is provided with a cut-out portion Rb which has a shape corresponding to a shape of the first outer electrode layer 12b and the second outer electrode layer 14b, and into which the first outer electrode layer 12b and the second outer electrode layer 14b are fitted. The element body layer 10b, and the entirety of the first outer electrode layer 12b and the second outer electrode layer 14b have a complementary relationship with each other.

The layer Lc is constituted by combining an element body layer 10c, and a first outer electrode layer 12c, a second outer electrode layer 14c, and a coil conductor layer 20c with each other. The element body layer 10c is provided with a cut-out portion Rc which has a shape corresponding to a shape of the first outer electrode layer 12c, the second outer electrode layer 14c, and the coil conductor layer 20c and into which the first outer electrode layer 12c, the second outer electrode layer 14c, and the coil conductor layer 20c are fitted. The element body layer 10c, and the entirety of the first outer electrode layer 12c, the second outer electrode layer 14c, and the coil conductor layer 20c have a complementary relationship with each other.

The layer Ld is constituted by combining an element body layer 10d, a first outer electrode layer 12d, a second outer electrode layer 14d, and a coil conductor layer 20d with each other. The element body layer 10d is provided with a cut-out portion Rd which has a shape corresponding to a shape of the first outer electrode layer 12d, the second outer electrode layer 14d, and the coil conductor layer 20d and into which the first outer electrode layer 12d, the second outer electrode layer 14d, and the coil conductor layer 20d are fitted. The element body layer 10d, and the entirety of the first outer electrode layer 12d, the second outer electrode layer 14d, and the coil conductor layer 20d have a complementary relationship with each other.

The layer Le is constituted by combining an element body layer 10e, a first outer electrode layer 12e, a second outer electrode layer 14e, and a coil conductor layer 20e with each other. The element body layer 10e is provided with a cut-out portion Re which has a shape corresponding to a shape of the first outer electrode layer 12e, the second outer electrode layer 14e, and the coil conductor layer 20e and into which the first outer electrode layer 12e, the second outer electrode layer 14e, and the coil conductor layer 20e are fitted. The element body layer 10e, and the entirety of the first outer electrode layer 12e, the second outer electrode layer 14e, and the coil conductor layer 20e have a complementary relationship with each other.

The layer Lf is constituted by combining an element body layer 10f, a first outer electrode layer 12f, a second outer electrode layer 14f, and a coil conductor layer 20f with each other. The element body layer 10f is provided with a cut-out portion Rf which has a shape corresponding to a shape of the first outer electrode layer 12f, the second outer electrode layer 14f, and the coil conductor layer 20f and into which the first outer electrode layer 12f, the second outer electrode layer 14f, and the coil conductor layer 20f are fitted. The element body layer 10f, and the entirety of the first outer electrode layer 12f, the second outer electrode layer 14f, and the coil conductor layer 20f have a complementary relationship with each other.

The layer Lg is constituted by combining an element body layer 10g, a first outer electrode layer 12g, a second outer electrode layer 14g, and a coil conductor layer 20g with each other. The element body layer 10g is provided with a cut-out portion Rg which has a shape corresponding to a shape of the first outer electrode layer 12g, the second outer electrode layer 14g, and the coil conductor layer 20g and into which the first outer electrode layer 12g, the second outer electrode layer 14g, and the coil conductor layer 20g are fitted. The element body layer 10g, and the entirety of the first outer electrode layer 12g, the second outer electrode layer 14g, and the coil conductor layer 20g have a complementary relationship with each other.

The layer Lh is constituted by combining an element body layer 10h, a first outer electrode layer 12h, a second outer electrode layer 14h, and a coil conductor layer 20h with each other. The element body layer 10h is provided with a cut-out portion Rh which has a shape corresponding to a shape of the first outer electrode layer 12h, the second outer electrode layer 14h, and the coil conductor layer 20h and into which the first outer electrode layer 12h, the second outer electrode layer 14h, and the coil conductor layer 20h are fitted. The element body layer 10h, and the entirety of the first outer electrode layer 12h, the second outer electrode layer 14h, and the coil conductor layer 20h have a complementary relationship with each other.

The layer Li is constituted by combining an element body layer 10i, a first outer electrode layer 12i, a second outer electrode layer 14i, and a coil conductor layer 20i with each other. The element body layer 10i is provided with a cut-out portion Ri which has a shape corresponding to a shape of the first outer electrode layer 12i, the second outer electrode layer 14i, and the coil conductor layer 20i and into which the first outer electrode layer 12i, the second outer electrode layer 14i, and the coil conductor layer 20i are fitted. The element body layer 10i, and the entirety of the first outer electrode layer 12i, the second outer electrode layer 14i, and the coil conductor layer 20i have a complementary relationship with each other.

Each of the layer Lj is constituted by combining an element body layer 10j, and a first outer electrode layer 12i and a second outer electrode layer 14j with each other. The element body layer 10j is provided with a cut-out portion Rj which has a shape corresponding to a shape of the first outer electrode layer 12j and the second outer electrode layer 14j, and into which the first outer electrode layer 12j and the second outer electrode layer 14j are fitted. The element body layer 10j, and the entirety of the first outer electrode layer 12j and the second outer electrode layer 14j have a complementary relationship with each other.

The layer Lk is constituted by an element body layer 10k, and a first outer electrode layer 12k and a second outer electrode layer 14k. The element body layer 10k is provided with a cut-out portion Rk which has a shape corresponding to a shape of the first outer electrode layer 12k and the second outer electrode layer 14k, and into which the first outer electrode layer 12k and the second outer electrode layer 14k are fitted. The element body layer 10k, and the entirety of the first outer electrode layer 12k and the second outer electrode layer 14k have a complementary relationship with each other.

An example of a method of manufacturing the stacked coil component 1 according to this embodiment will be described.

The first outer electrode layers 12a to 12k, the second outer electrode layers 14a to 14k, and conductor patterns that will be the coil conductor layers 20c to 20i are formed on the substrate (e.g., PET film, etc.) by soldering. The conductor patterns that will be the coil conductor layers 20c to 20i are formed may be formed by screen printing. Subsequently, the substrate is coated with enamel by screen printing, for example, so as to embed the perimeter of the conductor patterns. That is to say, a coating of enamel is applied so as to embed the step (margin) caused by the conductor patterns. Next, green sheets that will be the element body layers 10a to 10k are stacked by transferring each conductor pattern in order. A stacked body of the green sheets is formed by pressing from the stacking direction.

According to the above-described process, a stacked body that constitutes the stacked coil component 1 after a heat treatment is formed on the support body. Next, the obtained stacked body is cut out in a predetermined size. Next, a binder removal treatment is performed with respect to the cut stacked body, and then a heat treatment is performed. For example, a heat treatment temperature is approximately 650° C. to 750° C. After the heat treatment, electrolytic plating is performed with respect to the first outer electrode 4 and the second outer electrode 5 to form the second plated layer M2 and the third plated layer M3. According to this, the stacked coil component 1 obtained.

As described above, in the stacked coil component 1 according to this embodiment, the first plated layer M1 includes the joining surface S1 that is joined to the element body 2, and the plating surface S2 that is opposite to the joining surface S1 and is formed by plating. As described above, in the stacked coil component 1, since a surface that is opposite to the joining surface S1 in the first plated layer M1, that is, a surface of the first plated layer M1 is the plating surface S2, the surface of the first plated layer M1 has few cavities (voids). According to this, the surface of the first plated layer M1 becomes a dense surface with small unevenness and few defects. Accordingly, in the stacked coil component 1, an improvement of surface characteristics of the first outer electrode 4 and the second outer electrode 5 is realized. As a result, when solder-mounting the stacked coil component 1, wettability of a solder can be improved. Note that, the surface characteristics represent flatness, a density, and the like of the surface.

In the stacked coil component 1 according to this embodiment, each of the first outer electrode 4 and the second outer electrode 5 includes the second plated layer M2 and the third plated layer M3 which are disposed on the plating surface S2 of the first plated layer M1. In this configuration, since the plating surface S2 of the first plated layer M1 is a dense surface with small unevenness and few defects. The thickness of the second plated layer M2 and the third plated layer M3 which are disposed on the plating surface S2 can be reduced. According to this, a stress that occurs at the time of forming the second plated layer M2 and the third plated layer M3 can be reduced, and thus each of the first outer electrode 4 and the second outer electrode 5 can be suppressed from being peeled off from the element body 2.

In the stacked coil component 1 according to this embodiment, in the first outer electrode 4 and the second outer electrode 5, surface roughness of the joining surface S1 of the first plated layer M1 is larger than surface roughness of the plating surface S2. In this configuration, an improvement in the joining strength between the element body 2, and the first outer electrode 4 and the second outer electrode 5 can be realized due to an anchor effect. Accordingly, in the stacked coil component 1, the first outer electrode 4 and the second outer electrode 5 can be further suppressed from being peeled off.

In addition, since the surface roughness of the plating surface S2 is small (the plating surface S2 is a flat surface), a surface area of the second plated layer M2 and the third plated layer M3 formed on the plating surface S2 can be reduced. According to this, an area that is in contact with the air in the third plated layer M3 can be reduced, and thus the surface of the third plated layer M3 can be suppressed from being oxidized. Accordingly, it is possible to suppress deterioration of reliability of the stacked coil component 1.

In the stacked coil component 1 according to this embodiment, the first outer electrode 4 and the second outer electrode 5 are formed by a transfer method. According to this, in the first plated layer M1 of the first outer electrode 4 and the second outer electrode 5, the joining surface S1 can be set to have a shape conforming to the unevenness of the element body 2, and the plating surface S2 can be set to a surface with small unevenness.

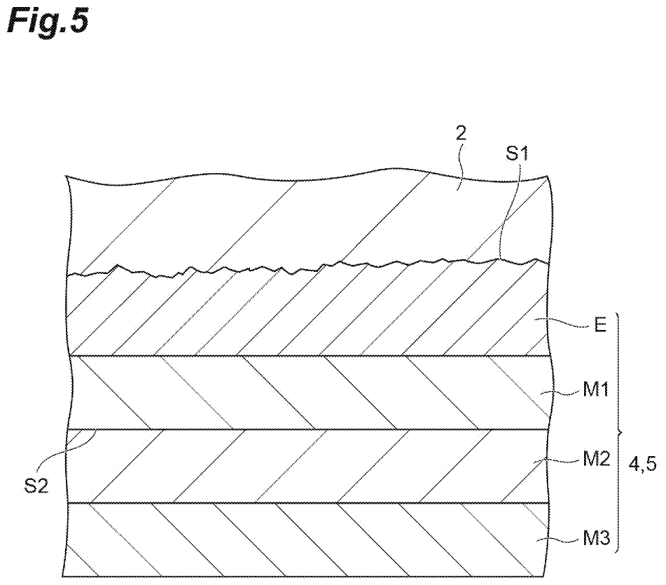

In the above-described embodiment, as illustrated in FIG. 4, description has been given with reference to an aspect in which each of the first outer electrode 4 and the second outer electrode 5 includes the first plated layer M1, the second plated layer M2, and the third plated layer M3. As illustrated in FIG. 5, each of the first outer electrode 4 and the second outer electrode 5 include a baked electrode layer E, the first plated layer M1, the second plated layer M2, and the third plated layer M3. The baked electrode layer E and the first plated layer M1 constitute an electrode portion. The electrode portion includes the joining surface S1 that is joined to the element body 2, and the plating surface S2 that is opposite to the joining surface S1.

The baked electrode layer E contains a conductive material (for example, Ag, Pd, or the like). In this embodiment, the conductive material is Ag. The baked electrode layer E is configured as a sintered body of a conductive paste containing a conductive metal powder (for example, an Ag powder) and a glass frit (glass component).

In the configuration of the first outer electrode 4 and the second outer electrode 5 illustrated in FIG. 5, the baked electrode layer E including the joining surface S1 that is joined to the element body 2 is provided, and the baked electrode layer E contains the glass frit. According to this, joining strength between the element body 2 and the baked electrode layer E can be secured. Accordingly, the first outer electrode 4 and the second outer electrode 5 can be suppressed from being peeled off from the element body 2.

### Second Embodiment

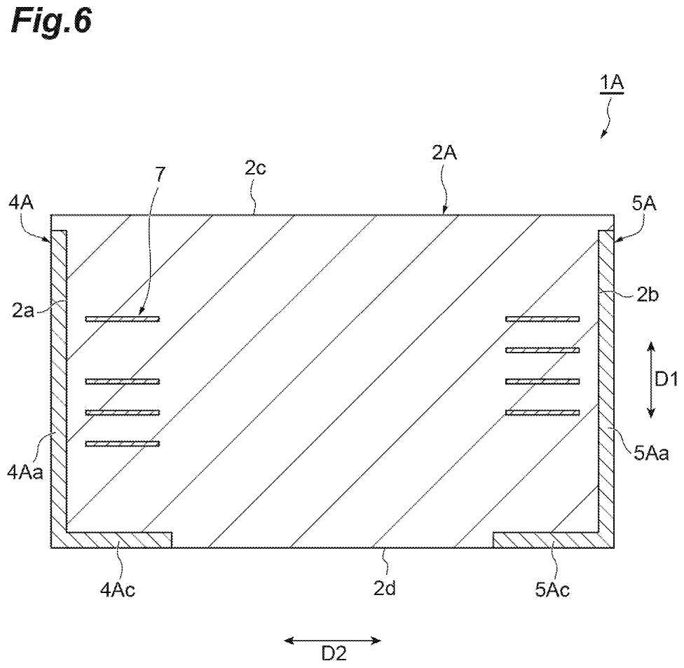

Next, a second embodiment will be described. As illustrated in FIG. 6, a stacked coil component 1A according to the second embodiment includes an element body 2A, and a first outer electrode 4A and a second outer electrode 5A which are respectively disposed at both ends of the element body 2A.

The first outer electrode 4A is disposed on one end surface 2a side. The first outer electrode 4A includes two electrode portions including a first electrode portion 4Aa located on the end surface 2a, and a second electrode portion 4Ac located on the main surface 2d. The first electrode portion 4Aa and the second electrode portion 4Ac are connected to a ridge portion of the element body 2A, and are electrically connected to each other. The first outer electrode 4A is formed on two surfaces including the one end surface 2a and the main surface 2d. The first electrode portion 4Aa and the second electrode portion 4Ac are integrally formed. In this embodiment, a surface of the second electrode portion 4Ac is flush with the main surface 2d. According to this configuration, it can be said that a part of the first outer electrode 4 is embedded in the element body 2A.

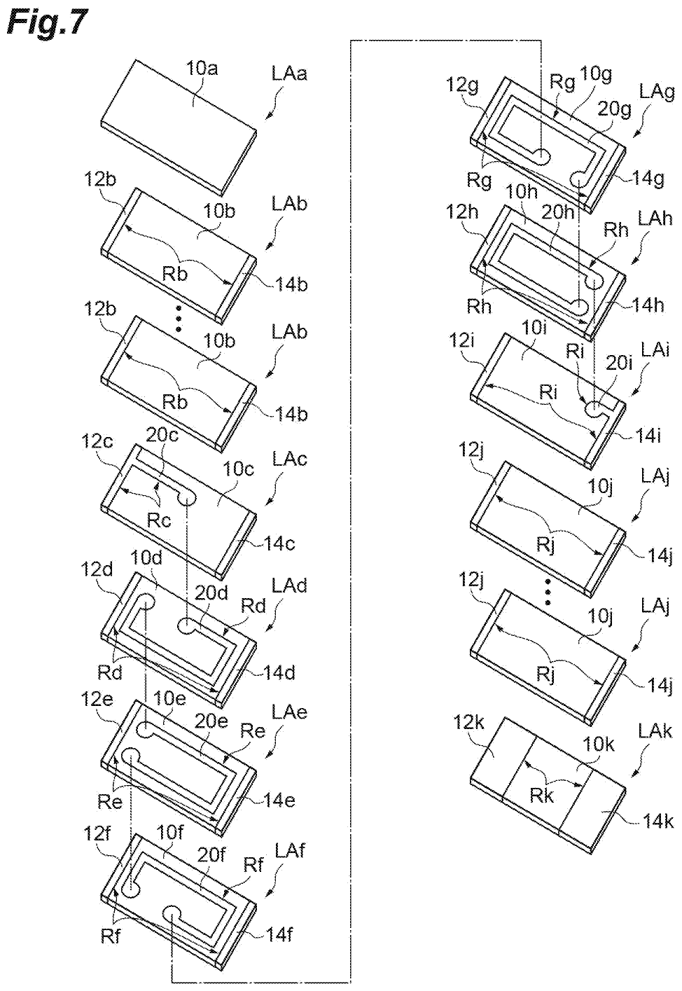

As illustrated in FIG. 7, the first outer electrode 4A is constituted by stacking a plurality of first outer electrode layers 12b, 12c, 12d, 12e, 12f, 12g, 12h, 12i, 12j, and 12k in the first direction D1. That is, a stacking direction of the first outer electrode layers 12b to 12k is the first direction D1. In an actual first outer electrode 4A, the plurality of first outer electrode layers 12b to 12k are integrated with each other to a certain extent in which a boundary between the layers cannot be visually recognized.

As illustrated in FIG. 6, the second outer electrode 5A is disposed on the one end surface 2b side. The second outer electrode 5A includes two electrode portions including a first electrode portion 5Aa located on the end surface 2b and a second electrode portion 5Ac located on the main surface 2d. The first electrode portion 5Aa and the second electrode portion 5Ac are connected to a ridge portion of the element body 2A, and are electrically connected to each other. The second outer electrode 5A is formed on two surfaces including the one end surface 2b and the main surface 2d. The first electrode portion 5Aa and the second electrode portion 5Ac are integrally formed. In this embodiment, a surface of the second electrode portion 5Ac is flush with the main surface 2d. According to this configuration, it can be said that a part of the second outer electrode 5A is embedded in the element body 2A.

As illustrated in FIG. 7, the second outer electrode 5A is constituted by stacking a plurality of second outer electrode layers 14b, 14c, 14d, 14e, 14f, 14g, 14h, 14i, 14j, and 14k in the first direction D1. That is, a stacking direction of the second outer electrode layers 14b to 14k is the first direction D1. In an actual second outer electrode 5A, the plurality of second outer electrode layers 14b to 14k are integrated with each other to a certain extent in which a boundary between the layers cannot be visually recognized.

Each of the first outer electrode 4A and the second outer electrode 5A has the same configuration as in each of the first outer electrode 4 and the second outer electrode 5 of the stacked coil component 1. That is, each of the first outer electrode 4A and the second outer electrode 5A includes the first plated layer M1, the second plated layer M2, and the third plated layer M3. Alternatively, each of the first outer electrode 4A and the second outer electrode 5A includes the baked electrode layer E, the first plated layer M1, the second plated layer M2, and the third plated layer M3.

As illustrated in FIG. 6, in the stacked coil component 1A, the coil 7 is disposed inside the element body 2A. As illustrated in FIG. 7, the coil 7 is constituted by connecting the coil conductor layers 20c, 20d, 20e, 20f, 20g, 20h, and 20i to each other. A coil axis of the coil 7 is provided along the first direction D1. The coil conductor layers 20c to 20i are arranged so that at least parts overlap each other when viewed from the first direction D1.

The stacked coil component 1A includes a plurality of layers LAa, LAb, LAc, LAd, LAe, LAf, LAg, LAh, LAi, LAj, and LAk. For example, the stacked coil component 1A is constituted by stacking a layer LAa, two layers LAb, a layer LAc, a layer LAd, a layer LAe, a layer LAf, a layer LAg, a layer LAh, a layer LAi, two layers LAj, and a layer LAk sequentially from the main surface 2c side.

The layers LAb, the layer LAc, the layer LAd, the layer LAe, the layer LAf, the layer LAg, the layer LAh, the layer LAi, the layers LAj, and the layer LAk have the same configuration as in the layers Lb, the layer Lc, the layer Ld, the layer Le, the layer Lf, the layer Lg, the layer Lh, the layer Li, the layers Lj, and the layer Lk of the stacked coil component 1 according to the first embodiment. The layer LAa is constituted by the element body layer 10a.

As described above, in the stacked coil component 1A according to this embodiment, the first plated layer M1 includes the joining surface S1 that is joined to the element body 2, and the plating surface S2 that is opposite to the joining surface S1 and is formed by plating. As described above, in the stacked coil component 1A, since a surface that is opposite to the joining surface S1 in the first plated layer M1, that is, a surface of the first plated layer M1 is the plating surface S2, the surface of the first plated layer M1 has few cavities (voids). According to this, the surface of the first plated layer M1 becomes a dense surface with small unevenness and few defects. Accordingly, in the stacked coil component 1A, an improvement of surface characteristics of the first outer electrode 4A and the second outer electrode 5A is realized.

### Third Embodiment

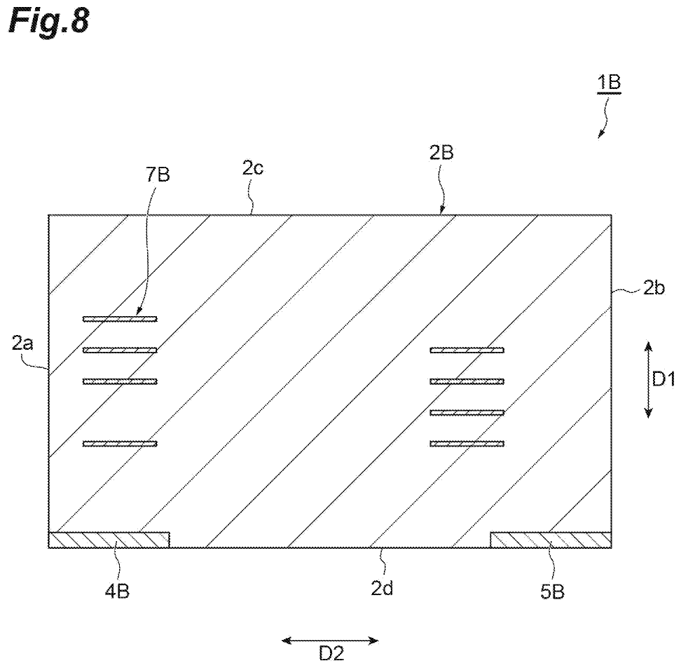

Next, a third embodiment will be described. As illustrated in FIG. 8, a stacked coil component 1B according to the third embodiment includes an element body 2B, a first outer electrode 4B, and a second outer electrode 5B.

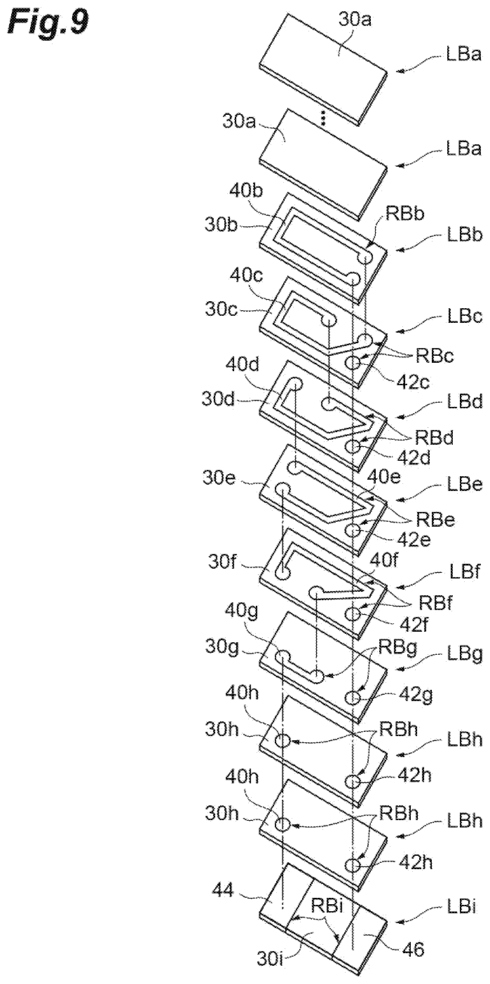

As illustrated in FIG. 9, the element body 2B is constituted by stacking a plurality of element body layers 30a to 30i. The element body layers 30a to 30i are stacked in the first direction D1. That is, the first direction D1 is a stacking direction. The element body 2B includes the stacked plurality of element body layers 30a to 30i. In an actual element body 2B, the plurality of element body layers 30a to 30i are integrated with each other to a certain extent in which a boundary between the layers cannot be visually recognized.

Each of the element body layers 30a to 30i contains a plurality of metal magnetic particles. The metal magnetic particles are composed of a soft magnetic alloy (soft magnetic material). For example, the soft magnetic alloy is an Fe—Si based alloy. In a case where the soft magnetic alloy is the Fe—Si based alloy, the soft magnetic alloy may contain P. For example, the soft magnetic alloy may be an Fe—Ni—Si—M based alloy. “M” includes one or more kinds of elements selected from Co, Cr, Mn, P, Ti, Zr, Hf, Nb, Ta, Mo, Mg, Ca, Sr, Ba, Zn, B, Al, and a rare-earth element.

In the element body layers 30a to 30i, the metal magnetic particles are coupled to each other. For example, coupling of the metal magnetic particles is realized by coupling of oxide films formed on surfaces of the metal magnetic particles. In the element body layers 30a to 30i, the metal magnetic particles are electrically insulated from each other due to coupling between the oxide films. For example, the thickness of each of the oxide films is 5 to 60 nm. The oxide film may be constituted by one or a plurality of layers.

The element body 2B contains a resin. The resin exists between a plurality of metal magnetic particles. The resin is a resin having an electrical insulation property (insulating resin). For example, the insulating resin includes a silicone resin, a phenolic resin, an acrylic resin, or an epoxy resin.

As illustrated in FIG. 8, in the element body 2B, a part of the main surface 2d forms a step. Specifically, each of the end surface 2a side and an end surface 2b side of the main surface 2d is further recessed toward the main surface 2c side in comparison to the central portion.

The first outer electrode 4B is disposed on one end surface 2a side in the main surface 2d. The first outer electrode 4B extends along the second direction D2 and the third direction D3, and has a rectangular shape when viewed from the first direction D1. In this embodiment, a surface of the first outer electrode 4B is flush with the main surface 2d. According to this configuration, it can be said that a part of the first outer electrode 4B is embedded in the element body 2B. As illustrated in FIG. 9, the first outer electrode 4B is constituted by a first outer electrode layer 44.

As illustrated in FIG. 8, the second outer electrode 5B is disposed on one end surface 2b side in the main surface 2d. The second outer electrode 5B extends along the second direction D2 and the third direction D3, and has a rectangular shape when viewed from the first direction D1. In this embodiment, a surface of the second outer electrode 5B is flush with the main surface 2d. According to this configuration, it can be said that a part of the second outer electrode 5B is embedded in the element body 2B. As illustrated in FIG. 9, the second outer electrode 5B is constituted by a second outer electrode layer 46.

Each of the first outer electrode 4B and the second outer electrode 5B has the same configuration as in each of the first outer electrode 4 and the second outer electrode 5 of the stacked coil component 1. That is, each of the first outer electrode 4B and the second outer electrode 5B includes the first plated layer M1, the second plated layer M2, and the third plated layer M3. Alternatively, each of the first outer electrode 4B and the second outer electrode 5B includes the baked electrode layer E, the first plated layer M1, the second plated layer M2, and the third plated layer M3.

As illustrated in FIG. 8, in the stacked coil component 1B, a coil 7B is disposed inside the element body 2B. As illustrated in FIG. 9, the coil 7B is constituted by connecting coil conductor layers 40b, 40c, 40d, 40e, 40f, 40g, and 40h, and coil conductor layers 42c, 42d, 42e, 42f, 42g, and 42h to each other. A coil axis of the coil 7B is provided along the first direction D1.

The coil conductor layers 40b to 40h, and the coil conductor layers 42c to 42h are constituted by a conductive material (for example, Ag or Pd). The respective layers may be constituted by the same material or may be constituted by materials different from each other.

The stacked coil component 1B includes a plurality of layers LBa, LBb, LBc, LBd, LBe, LBf, LBg, LBh, and LBi. For example, the stacked coil component 1B is constituted by stacking two layers LBa, a layer LBb, a layer LBc, a layer LBd, a layer LBe, a layer LBf, a layer LBg, two layers LBh, and a layer LBi sequentially from the main surface 2c side.

Each of the layers LBa is constituted by the element body layer 30a.

The layer LBb is constituted by combining the element body layer 30b and the coil conductor layer 40b with each other. The element body layer 30b is provided with a cut-out portion RBb which has a shape corresponding to a shape of the coil conductor layer 40b and into which the coil conductor layer 40b is fitted. The element body layer 30b and the entirety of the coil conductor layer 40b have a complementary relationship with each other.

The layer LBc is constituted by combining the element body layer 30c, the coil conductor layer 40c, and the coil conductor layer 42c with each other. The element body layer 30c is provided with a cut-out portion RBc which has a shape corresponding to a shape of the coil conductor layer 40c and the coil conductor layer 42c, and into which the coil conductor layer 40c and the coil conductor layer 42c are fitted. The element body layer 30c, and the entirety of the coil conductor layer 40c and the coil conductor layer 42c have a complementary relationship with each other.

The layer LBd is constituted by combining the element body layer 30d, and the coil conductor layer 40d and the coil conductor layer 42d with each other. The element body layer 30d is provided with a cut-out portion RBd which has a shape corresponding to a shape of the coil conductor layer 40d and the coil conductor layer 42d, and into which the coil conductor layer 40d and the coil conductor layer 42d are fitted. The element body layer 30d, and the entirety of the coil conductor layer 40d and the coil conductor layer 42d have a complementary relationship with each other.

The layer LBe is constituted by combining the element body layer 30e, and the coil conductor layer 40e and the coil conductor layer 42e with each other. The element body layer 30e is provided with a cut-out portion RBe which has a shape corresponding to a shape of the coil conductor layer 40e and the coil conductor layer 42e, and into which the coil conductor layer 40e and the coil conductor layer 42e are fitted. The element body layer 30e, and the entirety of the coil conductor layer 40e and the coil conductor layer 42e have a complementary relationship with each other.

The layer LBf is constituted by combining the element body layer 30f, and the coil conductor layer 40f and the coil conductor layer 42f with each other. The element body layer 30f is provided with a cut-out portion RBf which has a shape corresponding to a shape of the coil conductor layer 40f and the coil conductor layer 42f, and into which the coil conductor layer 40f and the coil conductor layer 42f are fitted. The element body layer 30f, and the entirety of the coil conductor layer 40f and the coil conductor layer 42f have a complementary relationship with each other.

The layer LBg is constituted by combining the element body layer 30g, and the coil conductor layer 40g and the coil conductor layer 42g with each other. The element body layer 30g is provided with a cut-out portion RBg which has a shape corresponding to a shape of the coil conductor layer 40g and the coil conductor layer 42g, and into which the coil conductor layer 40g and the coil conductor layer 42g are fitted. The element body layer 30g, and the entirety of the coil conductor layer 40g and the coil conductor layer 42g have a complementary relationship with each other.

Each of the layers LBh is constituted by combining the element body layer 30h, and the coil conductor layer 40h and the coil conductor layer 42h with each other. The element body layer 30h is provided with a cut-out portion RBh which has a shape corresponding to a shape of the coil conductor layer 40h and the coil conductor layer 42h, and into which the coil conductor layer 40h and the coil conductor layer 42h are fitted. The element body layer 30h, and the entirety of the coil conductor layer 40h and the coil conductor layer 42h have a complementary relationship with each other.

The layer LBi is constituted by combining the element body layer 30i, and the first outer electrode layer 44 and the second outer electrode layer 46 with each other. The element body layer 30i is provided with a cut-out portion RBi which has a shape corresponding to a shape of the first outer electrode layer 44 and the second outer electrode layer 46, and into which the first outer electrode layer 44 and the second outer electrode layer 46 are fitted. The element body layer 30i, and the entirety of the first outer electrode layer 44 and the second outer electrode layer 46 have a complementary relationship with each other.

As described above, in the stacked coil component 1B according to this embodiment, the first plated layer M1 includes the joining surface S1 that is joined to the element body 2, and the plating surface S2 that is opposite to the joining surface S1 and is formed by plating. As described above, in the stacked coil component 1, since a surface that is opposite to the joining surface S1 in the first plated layer M1, that is, a surface of the first plated layer M1 is the plating surface S2, the surface of the first plated layer M1 has few cavities (voids). According to this, the surface of the first plated layer M1 becomes a dense surface with small unevenness and few defects. Accordingly, in the stacked coil component 1B, an improvement of surface characteristics of the first outer electrode 4B and the second outer electrode 5B is realized.

Hereinbefore, the embodiments of the present disclosure have been described, but the present disclosure is not limited to the above-described embodiments, and various modifications can be made within a range not departing from the gist.

The element body 2 may not necessarily contain the metal magnetic particles, and may be constituted by ferrite (for example, Ni—Cu—Zn based ferrite, Ni—Cu—Zn—Mg based ferrite, or Cu—Zn based ferrite), a dielectric material, or the like.

In the above-described embodiments, description has been given with reference to an aspect in which each of the first outer electrode 4 and the second outer electrode 5 includes the first plated layer M1, the second plated layer M2, and the third plated layer M3. However, each of the first outer electrode 4 and the second outer electrode 5 may further include a plated portion (for example, a Cu plated layer), and the plated portion may be one layer (for example, Ag plated layer). In a case where the plated portion is only one layer, an electric resistivity of a DC resistor can be reduced.

The number of the coil conductors is not limited to the above-described value.

What is claimed is:

1. A coil component, comprising:
an element body;
a coil disposed inside the element body; and
an outer electrode disposed in the element body,
wherein the outer electrode includes an electrode portion which includes a joining surface joined to the element body and a plating surface opposite to the joining surface and is formed by plating, and of which at least a part is embedded in the element body.

2. The coil component according to claim 1,
wherein the outer electrode includes one or a plurality of plated layers disposed on the plating surface of the electrode portion.

3. The coil component according to claim 1,
wherein the element body is constituted by stacking element body layers containing a plurality of metal magnetic particles of a soft magnetic material.

4. The coil component according to claim 1,
wherein surface roughness of the joining surface is larger than surface roughness of the plating surface.

5. The coil component according to claim 1,
wherein the electrode portion includes a baked electrode layer that includes the joining surface and contains a glass component.
